(19) United States
(12) Patent Application Publication
(10) Pub. No.: US 2010/0292962 A1
(43) Pub. Date: Nov. 18, 2010

(54) SYSTEM AND METHOD FOR CONVERTING A CONVENTIONAL SURFACE INTO A NURBS SURFACE

(75) Inventors: Chih-Kuang Chang, Tu-Cheng (TW); Jin-Bo Hu, Shenzhen City (CN); Shao-Qin Xie, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/728,265

(22) Filed: Mar. 21, 2010

(30) Foreign Application Priority Data
May 15, 2009 (CN) 200910302363.X

(51) Int. Cl. G06F 17/50; G06F 17/10; G06T 17/00

(52) U.S. Cl. 703/1; 345/420; 703/2

(57) ABSTRACT

A system and method for converting a conventional surface into a non-uniform rational basis spline (NURBS) surface generates a constructed curve according to a first NURBS curve of the conventional surface which is read from a storage system. The system and method further converts the constructed curve into the second NURBS curve. Furthermore, the system and method constructs the NURBS surface based on the first NURBS curve and the second NURBS curve.

### BACKGROUND

1. Technical Field

Embodiments of the present disclosure relate to computer aided design (CAD) methods, and more particularly to a system and method for converting a conventional surface into a non-uniform rational basis spline (NURBS) surface.

2. Description of Related Art

A NURBS surface can offer great flexibility and precision for handling both analytic and freeform shapes. The NURBS surface can be efficiently handled by computer programs and be allowed for easy human interaction. However, it costs much time to convert a conventional surface (e.g., a ruled surface) into a NURBS surface.

What is needed, therefore, is a system and method for converting a conventional surface into a NURBS surface.

### BRIEF DESCRIPTION OF THE DRAWINGS

FIG. 1 is a block diagram of one embodiment of a computer comprising a surface conversion system.

FIG. 2 is a flowchart of one embodiment of a method for converting a ruled surface into a NURBS surface using the surface conversion system of FIG. 1.

FIG. 3 is a flowchart of one embodiment of a method for converting a cylindrical surface into a NURBS surface using the surface conversion system of FIG. 1.

FIG. 4 is a flowchart of one embodiment of a method for converting a rotating surface into a NURBS surface using the surface conversion system of FIG. 1.

FIG. 5 illustrates one embodiment of the ruled surface.

FIG. 6 illustrates one embodiment of the cylindrical surface.

FIG. 7 illustrates one embodiment of the rotating surface.

### DETAILED DESCRIPTION

All of the processes described below may be embodied in, and fully automated via, function modules executed by one or more general purpose computers or processors. The code modules may be stored in any type of computer-readable medium or other computer storage device. Some or all of the methods may alternatively be embodied in specialized computer hardware.

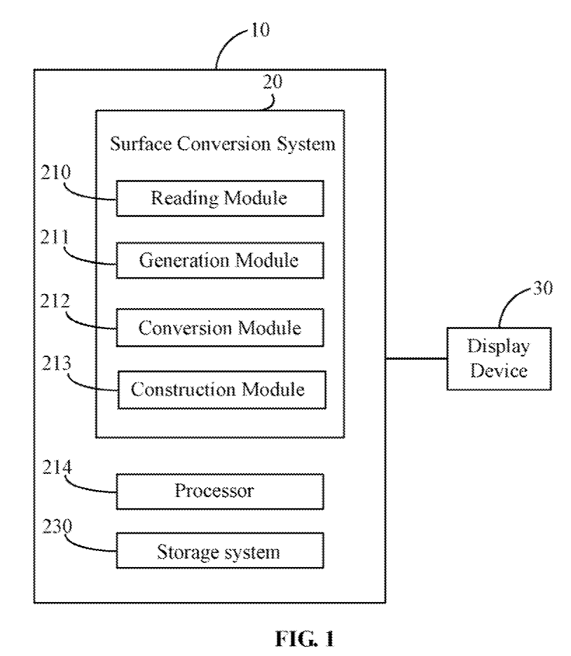

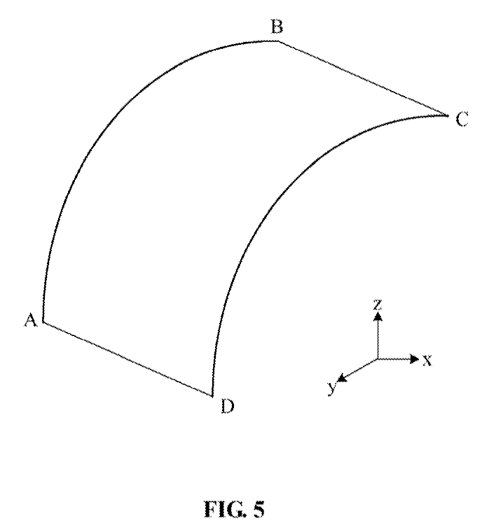

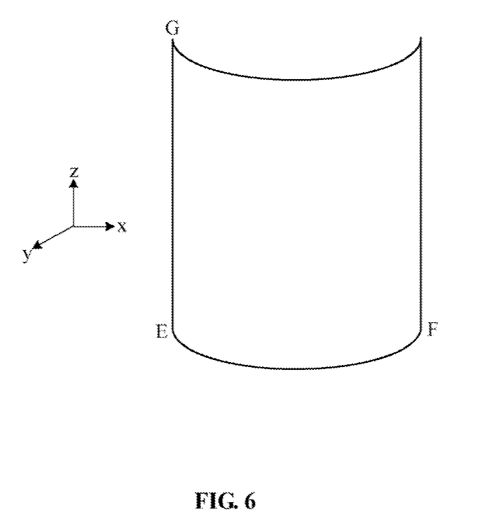

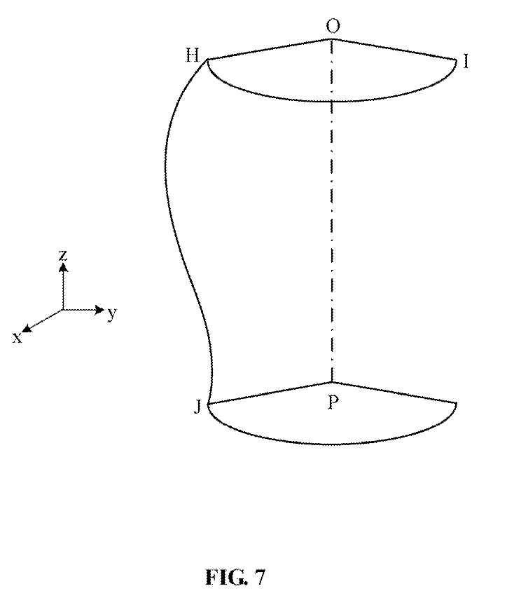

FIG. 1 is a block diagram of one embodiment of a computer 10 comprising a surface conversion system 20. In one embodiment, the surface conversion system 20 may be used to convert a conventional surface of an object into a non-uniform rational basis spline (NURBS) surface. In one embodiment, the conventional surface is defined by Initial Graphics Exchange Specification (IGES), and the conventional surface may be one of, but not limited to, a ruled surface, a cylindrical surface, and a rotating surface. In an exemplary embodiment, a ruled surface is shown in FIG. 5, a cylindrical surface is shown in FIG. 6, and a rotating surface is shown in FIG. 7.

The computer 10 may be a personal computer (PC), a network server, or any other appropriate data-processing equipment. The computer 10 includes a storage system 230 and a processor 214. The storage system 230 stores a plurality of parameters of the ruled, cylindrical, and rotating surface. For example, the parameters of the ruled surface can comprise two boundary curves and a value range for each boundary curve. As shown in FIG. 5, the two boundary curves are A-B and C-D. The parameters of the cylindrical surface can comprise a boundary curve, a boundary point, a value range of the boundary curve, and coordinates of the boundary point. As shown in FIG. 6, the boundary curve is E-F, and the boundary point is G. The parameters of the rotating surface can comprise a generatrix, a shaft and a rotating angle. As shown in FIG. 7, the generatrix is H-J, the shaft is O-P, and the rotating angle is ∠HOI.

The computer 10 is connected to a display device 30. The display device 30 may display the NURBS surface. It should be understood that the NURBS surface has become an industry standard for the representation, design, and data exchange of geometric information processed by computers. In one embodiment, the mathematical expression of the NURBS surface is expressed as the equation of:

$$S ( u , v ) = \frac{{\sum }_{i = 0}^{M} {\sum }_{k = 0}^{L} {w}_{i} {P}_{i , k} {N}_{i , m} ( u ) , {N}_{k , n} ( v )}{{\sum }_{i = 0}^{M} {\sum }_{k = 0}^{N} {w}_{i} {P}_{i , k} {N}_{i , m} ( u ) , {N}_{k , n} ( v )} .$$

In above equation, S(u,v) is a vectorial expression of parametric equations; {P_{1,k} } are control points; {w_{i,k}} are weights of the control points; N_{1,m} (u) and N_{k,n} (v) are two B-Spline basic functions.

It is understood that the NURBS surface is constructed by two NURBS curves \vec{C}(u) and \vec{C}(v). In one embodiment, the mathematical expression of the NURBS curve \vec{C}(u) is expressed as the equation of:

$$\vec{C} ( u ) = \frac{{\sum }_{i = 0}^{n} {N}_{i , p} ( u ) {w}_{i} {\vec{P}}_{i}}{{\sum }_{i = 0}^{n} {N}_{i , p} ( u ) {w}_{i}} 0 \leq u \leq 1.$$

In the above equation, \vec{C}(u) is a vectorial expression of parametric equations; N_{i,p}(u) are B-Spline basic functions; \vec{P}₁ are vectors of control points; u is a parameter; Wi is a weight for the control point i; p is a basic function degree; and n+1 is a number of the control points. The control points form what is called the ‘control polygon’. There are two parametric equations in two dimensional (2D) space and one for each coordinate. The equations are a function of the parameter u. Each of the control points has a weighting factor associated with it. The weighting factor has the effect of pulling the curve closer to the control points. In one embodiment, if the NURBS curve \vec{C}(u) has four control points, and the NURBS curve knots are {0,0,0,0,1,1,1,1}, then the head control points and the tail control points are superposed on the endpoints of the NURBS curve \vec{C}(u).

In one embodiment, the surface conversion system 20 comprises a reading module 210, a generation module 211, a conversion module 212, and a construction module 213. One or more computerized codes of the modules 210-213 are stored in the storage system 230. One or more general purpose or specialized processors, such as a processor 214 executes the computerized codes of the modules 210-213 to provide one or more operations of the surface conversion system 20. Further details of these modules 210-213 will be explained below.

The reading module 210 reads a first NURBS curve of the conventional surface from the storage system 230. In one embodiment, if the conventional surface is the ruled surface, the reading module 210 reads the boundary curve A-B and C-D (as shown in FIG. 5). The boundary curve A-B or the boundary curve C-D is regarded as the first NURBS curve. If the conventional surface is the cylindrical surface, the reading module 210 reads the boundary curve E-F and the coordinates of the boundary point G (as shown in FIG. 6). The boundary curve E-F is regarded as the first NURBS curve. If the conventional surface is the rotating surface, the reading module 210 reads the generatrix H-J, the shaft O-P, and the rotating angle ∠HOI (as shown in FIG. 7). The generatrix H-J is regarded as the first NURBS curve.

The generation module 211 generates a constructed curve according to the first NURBS curve of the conventional surface. In one embodiment, if the conventional surface is the ruled surface, as shown in FIG. 5, then the constructed curve is line-segment A-D, and the line-segment A-D is vertical to the boundary curve A-B and C-D. Further details of how to generate the boundary curve A-B and the line-segment A-D are described with respect to FIG. 5. In another embodiment, if the conventional surface is the cylindrical surface, then the constructed curve is line-segment G-E, and the line-segment G-E is vertical to the boundary curve E-F. Further details of how to generate the line-segment G-E are described with respect to FIG. 6. In another embodiment, if the conventional surface is the rotating surface, then the constructed curve is arc H-I. The arc H-I is vertical to the shaft O-P, and the radian of the arc H-I is the rotating angle ∠HOI. Further details of how to generate the arc H-I are described with respect to FIG. 7.

The conversion module 213 converts the constructed curve into a second NURBS curve. In one embodiment, the conversion module 213 converts the constructed curve into the second NURBS curves, so that the constructed curve is expressed by the mathematical expression of the NURBS curve as mentioned above.

The construction module 214 constructs the NURBS surface based on the first NURBS curve and the second NURBS curve. Specifically, the construction module 214 constructs control points of the NURBS surface. For example, the control points of the first NURBS curve and the second NURBS curve is represented as {U₁, U₂} and {V₁, V₂} and the control points of the NURBS surface are constructed into {(U₁, V₁), (U₁, V₂), (U₂,V₁), (U₂,V₂)}. The construction module 214 constructs weights of the control points of the NURBS surface. For example, the weights for the control points of the first NURBS curves is represented as {W₁,W₂} and the weights for the control points of the second NURBS curves is represented as {L₁, L₂}. Then the weights for the control points of the NURBS surface are constructed into {(W₁*L₁),(W₁*L₁),(W₂*L₂)}. The construction module 214 constructs B-Spline basic functions of the NURBS surface. For example, the B-Spline basic functions of the first NURBS curve are {M₁,M₂} and the B-Spline basic functions of the second NURBS curve are {N₁,N₂}. Then the B-Spline basic functions of the NURBS surface are constructed into {(M₁,N₁),(M₁, N₂), (M₂, N₁), (M₂, N₂)}. The construction module 214 substitutes {(U₁, V₁), W₁, V₂), (U₂, V₁), (U₂, V₂)}, {(W₁*L₁), (W₁*L₂), (W₂*L₁), (W₂*L₂)} and {(M₁,N₁),(M₁,N₂),(M₂,N₁),(M₂,N₂)} into the mathematical expression of the NURBS surface as mentioned above. Then the NURBS surface is constructed.

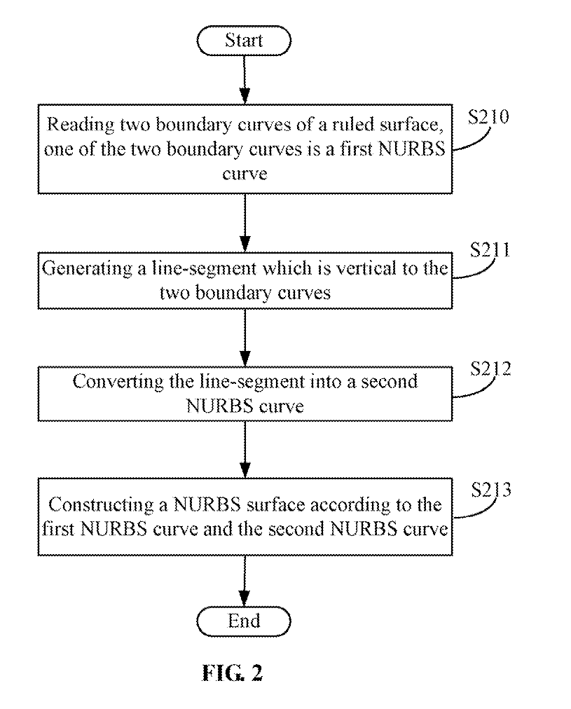

FIG. 2 is a flowchart of one embodiment of a method for converting a ruled surface into a NURBS surface.

In block S210, the reading module 210 reads two boundary curves of a ruled surface from the storage system 230, one of the two boundary curves is regarded as a first NURBS curve. As mentioned above, the reading module 210 reads the boundary curve A-B and the boundary curve C-D, the boundary curve A-B or the boundary curve C-D is regarded as the first NURBS curve.

In block S211, the generation module 211 generates a line-segment which is vertical to the two boundary curve. In one embodiment, the line-segment A-D is vertical to the boundary curve A-B and C-D. The generation module 211 generates the line-segment A-D according to the boundary curve A-B and C-D. For example, if (x₀,y₀) are coordinates of the head point A of the boundary curve A-B, and (x₁, y₁) are coordinates of the head point D of the boundary curve C-D, the mathematical expression of the line-segment A-D is expressed as the equation: L={A,D}, l(u)={(x₀+(x₁−x₀)*u,y₀+(y₁−y₀)*u|uε[0,1]}.

In block S212, the conversion module 212 converts the generated line-segment into a second NURBS curve. As mentioned above, the conversion module 212 converts the line-segment A-D into NURBS curves, so that the line-segment A-D is expressed from the mathematical expression L={A,D}, l(u)={x₀+(x₁−x₀)*u, y₀+(y₁−y₀)*u|u ε[0,1]} into the mathematical expression of the NURBS curve as mentioned above.

In block S213, the construction module 213 constructs the NURBS surface based on the first NURBS curve and the second NURBS curve. As mentioned above, the method of construction is followed: (1) the first NURBS curve A-B is represented as {U₁,U₂} and the second NURBS curve A-D is represented as {V₁, V₂}, then the control points of the NURBS surface are constructed into {(U₁,V₁), (U₁, V₂), (U₂,V₁), (U₂,V₂)}; (2) the weights for the first NURBS curve A-B is represented as {W₁, W₂} and the weights for second NURBS curve A-D is represented as {L₁,L₂}; then the weights for the control points of the NURBS surface are constructed into {(W₁*L₁), (W₁*L₂), (W₂*L₁); (W₂*L₂)}; (3) the B-Spline basic functions of the first NURBS curve A-B is represented as {M₁ ,M₂} and the B-Spline basic functions of the second NURBS curve A-D is represented as {N₁, N₂}, then the B-Spline basic functions of the NURBS surface are constructed into {(M₁, N₁), (M₁, N₂); (M₂; N₁); (M₂; N₂)}; (4) substituting {(U₁, V₁),(U₁, V₂); (U₂; V₁); (U₂; V₂)}, {(W₁*L₁), (W₁*L₂); (W⁷₂*L₁); (W₂*L₂)} and {(M₁, N₁), (M₁, N₂), (M₂, N₁), (M₂, N₂)} into the mathematical expression of the NURBS surface mentioned above, then the NURBS surface is constructed.

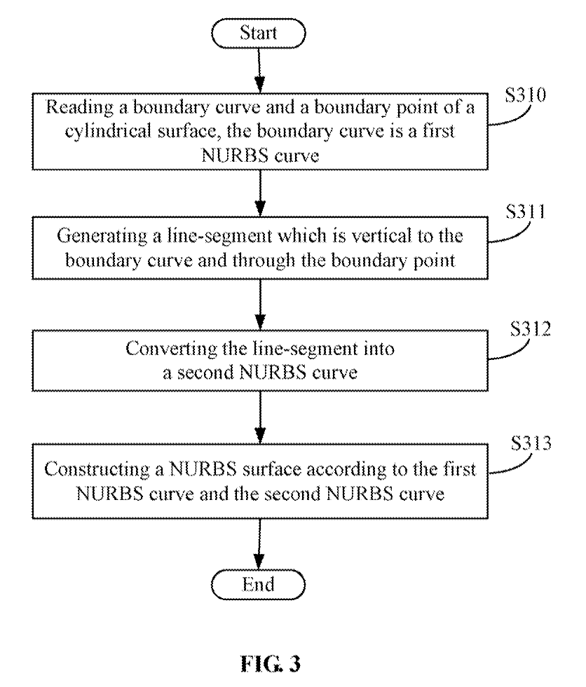

FIG. 3 is a flowchart of one embodiment of a method for converting a cylindrical surface into a NURBS surface.

In block S310, the reading module 210 reads a boundary curve and a boundary point of the cylindrical surface from the storage system 230, the boundary curve is regarded as a first NURBS curve. As mentioned above, the reading module 210 reads the boundary curve E-F and the coordinates of the boundary point G, the boundary curve E-F is regarded as the first NURBS curve.

In block S311, the generation module 211 generates a line-segment which is vertical to the boundary curve. In one embodiment, the generation module 211 generates the line G-E according to the boundary curve G-E and coordinates of the boundary point G, for example, assumption that E₀(x₀,y₀) are coordinates of the head point E of the boundary curve E-F, and G₁(x₁,y₁) are coordinates of the head boundary point G, then the mathematical expression of the line-segment G-E is expressed as the equation: L={E₀,G₁}, l(u)={x₀+x₀)*u,y₀+(y₁−y₀)*u u [0,1]}.

In block S312, the conversion module 212 converts the line-segment into a second NURBS curve. As mentioned above, the conversion module 213 converts the line-segment G-E into the NURBS curves, so that the line-segment G-E is expressed from the mathematical expression L={E₀, G₁} l(u)={x₀+(x₁−x₀)*u, y₀+(y₁−y₀)*u|u E [0,1]} into the mathematical expression of the NURBS curve mentioned above.

In block S313, the construction module 213 constructs the NURBS surface based on the first NURBS curve and the second NURBS curve. As mentioned above, the method of construction is followed: (1) the control points of the first NURBS curve E-F is represented as {U₁,U₂ } and the control points of the second NURBS curve G-E is represented as {V₁, V₂ }; then the control points of the NURBS surface are constructed into {(U₁,V₁), (U₁, V₂), (U₂,V₁), (U₂,V₂)}; (2) the weights for the first NURBS curves E-F is represented as {W₁, W₂} and the weights for the second NURBS curves G-E is represented as {L₁,L₂}, then the weights for the control points of the NURBS surface are constructed into {(W₁*L₁), (W₁*L₂), (W₂*L₁), (W₂*L₂)}; (3) the B-Spline basic functions of the first NURBS curves E-F is represented as {M₁, M₂} and the B-Spline basic functions of the first NURBS curves G-E is represented as {N₁, N₂ }, then the B-Spline basic functions of the NURBS surface are constructed into {(M₁,N₁),(M₁,N₂),(M₂,N₁),(M₂,N₂)}(4) substituting {(U₁, V₁), (U₁, V₂), (U₂, V₁), (U₂, V₂)}, {(W₁*L₁),(W*L₂),(W₂*L₁),(W₂*L₂)} and {(M₁,N₁),(M₁, N₂),(M₂,N₁),(M₂N₂)} into the mathematical expression of the NURBS surface mentioned above, then the NURBS surface is constructed.

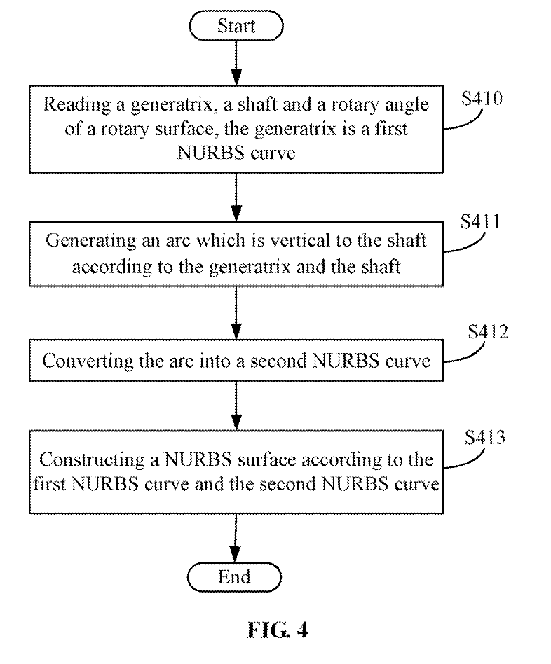

FIG. 4 is a flowchart of one embodiment of a method for converting a rotating surface into a NURBS surface.

In block S410, the reading module 210 reads a generatrix, a shaft and a rotating angle of a rotating surface from the storage system 230, the generatrix is regarded as a first NURBS curve. As mentioned above, the reading module 210 reads the generatrix H−J, the shaft O-P and the rotating angle ∠HOI, the generatrix H-J is regarded as the first NURBS curve.

In block 5411, the generation module 211 generates an arc which is vertical to the generatrix. As mentioned above, the generation module 211 generates the arc H-I according to the generatrix H-J, the shaft O-P and the rotating angle ∠HOI, for example, assumption that H (xₛₜₐᵣₜ,yₛₜₐᵣₜ) are coordinates of the head point H of the generatrix H-J, and O₁(x_{center},y_{center}) are coordinates of the head point O of the shaft O-P, θ is the angle degree of the rotating angle ∠HOI, then the mathematical expression of the arc H-I is expressed as the equation: Arc(θ)=(X_{center}+R*cos θ, y_{center}+R*sinθ), θε[θₛₜₐᵣₜ,θ_{end}],R=\sqrt{(xₛₜₐᵣₜ−x_{center})²+(yₛₜₐᵣₜ−y_{center})²}.

In block S412, the conversion module 212 converts the arc into the NURBS curves. As mentioned above, the conversion module 213 converts the arc H-I into the NURBS curves, so that the arc H-I is expressed from the mathematical expression Arc(θ)=(x_{center}+R*cosθ,y_{center}+R*sin θ, θε8 θₛₜₐᵣₜ,θ_{end}, R=\sqrt{(Xₛₜₐᵣₜ−X_{center})² (yₛₜₐᵣₜ−y_{center})²} to the mathematical expression of the NURBS curve mentioned above.

In block 5413, the construction module 213 constructs the NURBS surface based on the first NURBS curve and the second NURBS curve. As mentioned above, the method of construction is followed: (1) the control points of the first NURBS curve H-J is represented as {U₁,U₂}, the control points of the second NURBS curve H-J is represented as {V₁, V₂}, then the control points of the NURBS surface are constructed into {(U₁, V₁), (U₁,V₂), (U₂,V₁),(U₂,V₂)}; (2) the weights for the first NURBS curve H-J is represented as {W₁, W₂}, the weights for the second NURBS curve H-I is represented as {L₁,L₂}, then the weights for the control points of the NURBS surface are constructed into {(W₁*L₁),(W₁*L₂), (W₂*L₁), (W₂*L₂)}; (3) the B-Spline basic functions of the first NURBS curve H-J are {M₁, M₂}, and the B-Spline basic functions of the first NURBS curve H-I are {N₁,N₂}, then the B-Spline basic functions of the NURBS surface are constructed into {(M₁, N₁), (M₁, N₂), (M₂, N₁), (M₂, N₂)}; (4) substituting {(U₁, V₁),(U₁, V₂),(U₂, V₁),(U₂,V₂)},{(W₁*L₁),(W₁*L₂),(W₂*L₁),(W₂*L₂)} and {(M₁,N₁),(M₁, N₂),(M₂,N₁),(M₂,N₂)} into the mathematical expression of the NURBS surface mentioned above, then the NURBS surface is constructed.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A surface converting system, the system comprising:
a storage system;
at least one processor; and
one or more programs stored in the storage system and being executable by the at least one processor, the one or more programs comprising:
a reading module operable to read a first non-uniform rational basis spline (NURBS) curve of a conventional surface of an object from the storage system;
a generation module operable to generate a constructed curve according to the first NURBS curve of the conventional surface;
a conversion module operable to convert the constructed curve into a second NURBS curve; and
a construction module operable to construct a NURBS surface according to the first NURBS curve and the second NURBS curve.

2. The system of claim 1, wherein the conventional surface is a ruled surface, the ruled surface comprises two boundary curves with one of the two boundary curves being the first NURBS curve, and the constructed curve is a line-segment which is vertical to the two boundary curves.

3. The system of claim 1, wherein the conventional surface is a cylindrical surface, the cylindrical surface comprises a boundary curve and a boundary point with the boundary curve being the first NURBS curve, and the constructed curve is a line-segment which is vertical to the boundary curve and runs through the boundary point.

4. The system of claim 1, wherein the conventional surface is a rotating surface, the rotating surface comprises a generatrix, a shaft and a rotating angle with the generatrix being the first NURBS curve, and the constructed curve is an arc which is vertical to the shaft, the radian of the arc is the rotating angle.

5. The system of claim 1, wherein the first NURBS curve and the second NURBS curve is expressed as an equation of:
$$\vec{C} ( u ) = \frac{{\sum }_{i = 0}^{n} {N}_{i , p} ( u ) {w}_{i} {\vec{P}}_{i}}{{\sum }_{i = 0}^{n} {N}_{i , p} ( u ) {w}_{i}} 0 \leq u \leq 1$$
wherein \vec{C}(u) is a vectorial expression of parametric equations; N_{i,p}(u) are B-Spline basic functions; \vec{P}ᵢ are vectors of control points; Wi is a weight for the control point i; p is the basic function degree; and n+1 is a number of the control points.

6. The system of claim 1, wherein the NURBS surface is expressed as an equation of:
$$S ( u , v ) = \frac{{\sum }_{i = 0}^{M} {\sum }_{k = 0}^{L} {w}_{i} {P}_{i , k} {N}_{i , m} ( u ) , {N}_{k , n} ( v )}{{\sum }_{i = 0}^{M} {\sum }_{k = 0}^{N} {w}_{i} {P}_{i , k} {N}_{i , m} ( u ) , {N}_{k , n} ( v )}$$
wherein S(u,v) is a vectorial expression of parametric equations; {P_{i,k}} are control points; {w_{i,k}} are weights of the control points; N_{i,m}(u) and N_{k,n}(v) are two B-Spline basic functions.

7. A computer-implemented method for converting a conventional surface into a non-uniform rational basis spline (NURBS) surface, the method comprising:
reading a first NURBS curve of the conventional surface of an object from a storage system;
generating a constructed curve according to the first NURBS curve of the conventional surface;
converting the constructed curve into a second NURBS curve; and
constructing the NURBS surface according to the first NURBS curve and the second NURBS curve.

8. The method of claim 7, wherein the conventional surface is a ruled surface, the ruled surface comprises two boundary curves with one of the two boundary curves being the first NURBS curve, and the constructed curve is a line-segment which is vertical to the two boundary curves.

9. The method of claim 7, wherein the conventional surface is a cylindrical surface, the cylindrical surface comprises a boundary curve and a boundary point with the boundary curve being the first NURBS curve, and the constructed curve is a line-segment which is vertical to the boundary curve and runs through the boundary point.

10. The method of claim 7, wherein the conventional surface is a rotating surface, the rotating surface comprises a generatrix, a shaft and a rotating angle with the generatrix being the first NURBS curve, and the constructed curve is an arc which is vertical to the shaft, the radian of the arc is the rotating angle.

11. The method of claim 7, wherein the first NURBS curve and the second NURBS curve is expressed as an equation of:
$$\vec{C} ( u ) = \frac{{\sum }_{i = 0}^{n} {N}_{i , p} ( u ) {w}_{i} {\vec{P}}_{i}}{{\sum }_{i = 0}^{n} {N}_{i , p} ( u ) {w}_{i}} 0 \leq u \leq 1$$
wherein \vec{C}(u) is a vectorial expression of parametric equations; N_{i,p}(u) are B-Spline basic functions; \vec{P}ᵢ are vectors of control points; Wi is a weight for the control point i; p is a basic function degree; and n+1 is a number of the control points.

12. The method of claim 7, wherein the NURBS surface is expressed as an equation of:
$$S ( u , v ) = \frac{{\sum }_{i = 0}^{M} {\sum }_{k = 0}^{L} {w}_{i} {P}_{i , k} {N}_{i , m} ( u ) , {N}_{k , n} ( v )}{{\sum }_{i = 0}^{M} {\sum }_{k = 0}^{N} {w}_{i} {P}_{i , k} {N}_{i , m} ( u ) , {N}_{k , n} ( v )}$$
wherein S(u,v) is a vectorial expression of parametric equations; {P_{i,k}} are control points; {w_{i,k}} are weights of the control points; N_{i,m} (u) and N_{k,n}(v) are two B-Spline basic functions.

13. A computer-readable medium having stored thereon instructions that, when executed by a computer, causing the computer to perform a method for converting a conventional surface into a non-uniform rational basis spline (NURBS) surface, the method comprising:
reading a first NURBS curve of the conventional surface from a storage system;
generating a constructed curve according to the first NURBS curve of the conventional surface;
converting the constructed curve into a second NURBS curve; and
constructing the NURBS surface based on the first NURBS curve and the second NURBS curve.

14. The medium of claim 11, wherein the conventional surface is a ruled surface, the ruled surface comprises two boundary curves with one of the two boundary curves being the first NURBS curve, and the constructed curve is a line-segment which is vertical to the two boundary curves.

15. The medium of claim 14, wherein the conventional surface is a cylindrical surface, the cylindrical surface comprises a boundary curve and a boundary point with the boundary curve being the first NURBS curve, and the constructed curve is a line-segment which is vertical to the boundary curve and runs through the boundary point.

16. The medium of claim 14, wherein the conventional surface is a rotating surface, the rotating surface comprises a generatrix, a shaft and a rotating angle with the generatrix being the first NURBS curve, and the constructed curve is an arc which is vertical to the shaft, the radian of the arc is the rotating angle.

17. The medium of claim 14, wherein the first NURBS curve and the second NURBS curve is expressed as an equation of:
$$\vec{C} ( u ) = \frac{{\sum }_{i = 0}^{n} {N}_{i , p} ( u ) {w}_{i} {\vec{P}}_{i}}{{\sum }_{i = 0}^{n} {N}_{i , p} ( u ) {w}_{i}} 0 \leq u \leq 1$$
wherein \vec{C}(u) is a vectorial expression of parametric equations; N_{i,p}(u) are B-Spline basic functions; \vec{P}ᵢ are vectors of control points; Wi is a weight for the control point i; p is a basic function degree; and n+1 is a number of the control points.

18. The medium of claim 14, wherein the NURBS surface is expressed as an equation of:
$$S ( u , v ) = \frac{{\sum }_{i = 0}^{M} {\sum }_{k = 0}^{L} {w}_{i} {P}_{i , k} {N}_{i , m} ( u ) , {N}_{k , n} ( v )}{{\sum }_{i = 0}^{M} {\sum }_{k = 0}^{N} {w}_{i} {P}_{i , k} {N}_{i , m} ( u ) , {N}_{k , n} ( v )}$$
wherein S(u,v) is a vectorial expression of parametric equations; {P_{i,k}} are control points; {w_{i,k}} are weights of the control points; N_{i,m} (u) and N_{k,n}(v) are two B-Spline basic functions.
